(19) United States
(12) Patent Application Publication
(10) Pub. No.: US 2025/0097733 A1
(43) Pub. Date: Mar. 20, 2025

(54) SYSTEM AND METHOD FOR ENERGY-OPTIMIZED UAV-ASSISTED UNDERWATER WIRELESS SENSOR NETWORK

(71) Applicant: INDIAN INSTITUTE OF TECHNOLOGY KHARAGPUR, Kharagpur (IN)

(72) Inventors: Sandeep VERMA, Kharagpur (IN); Md. Shahbaz AKHTAR, Kharagpur (IN); Aneek ADHYA, Kharagpur (IN)

(73) Assignee: INDIAN INSTITUTE OF TECHNOLOGY KHARAGPUR, Kharagpur (IN)

(21) Appl. No.: 18/800,359

(22) Filed: Aug. 12, 2024

(30) Foreign Application Priority Data
Sep. 19, 2023 (IN) 202331062885

(51) Int. Cl. H04W 24/02; H04W 52/02; H04W 84/06; H04W 84/18

(52) U.S. Cl. CPC H04W 24/02; H04W 52/0203; H04W 84/06; H04W 84/18

(57) ABSTRACT

It is quite apparent that deployment of different sensors or combination of different sensors in underwater sensor network (UWSNs) helps researchers and environmentalists to gather valuable data on oceanography, marine life, water quality, and environmental changes in underwater ecosystems, contributing to a better understanding of the planet's aquatic environments. Therefore, the present invention is directed to provide a system and method for establishing energy-optimized UAV-assisted underwater wireless sensor network (FIG. 1) to collect data from sensor nodes placed underwater through deployment of a set number of gateway nodes equipped with solar harvesting module embedded on to them. The purpose of this invention is to reduce the impact of the hot-spot issue in UWSN.

### FIELD OF THE INVENTION

The present invention relates to underwater wireless sensor network (UWSN). More specifically, the present invention is directed to provide a system and method for establishing energy-optimized UAV-assisted underwater wireless sensor network to collect data from sensor nodes placed underwater through deployment of a set number of gateway nodes equipped with solar harvesting module embedded on to them. The purpose of this invention is to reduce the impact of the hot-spot issue in UWSN.

### BACKGROUND OF THE INVENTION

Energy harvesting nodes in Underwater Wireless Sensor Networks (UWSNs) face several challenging conditions due to the aquatic environment where they operate in. Some of the key difficulties are listed below:

Limited Energy Resources: Energy harvesting nodes typically rely on ambient energy sources, such as solar, acoustic, or vibrational energy, to power their operations. However, the availability of these energy sources underwater is limited compared to terrestrial environments, making it challenging to generate and store sufficient energy for continuous sensor node operation.

Harsh Communication Medium: Water is a highly attenuating and dispersive medium for wireless communication. The high attenuation of radio waves and the scattering of acoustic signals in water pose significant challenges for reliable and long-range communication between underwater nodes.

Mobility Constraints: Some underwater sensor networks may be deployed in mobile or dynamic environments, such as in the presence of ocean currents or marine life. This can lead to changes in node positions and network topology, requiring adaptive energy harvesting techniques to keep nodes powered and connected.

Depth and Pressure: The depth at which UWSNs operate can introduce high pressure on the sensor nodes. This pressure can affect the integrity and performance of the energy harvesting components, which must be designed to withstand such conditions.

Corrosion and Fouling: Submerged sensor nodes are exposed to corrosive elements and marine organisms that can accumulate on the node's surface, leading to fouling. This fouling can reduce the efficiency of energy harvesting components and compromise the node's functionality over time.

Sensing and Processing Challenges: Underwater sensors may be required to operate in harsh and unpredictable conditions. They must be designed to tolerate variations in water temperature, salinity, and other environmental factors while maintaining accurate and reliable sensing capabilities.

Limited Data Transmission: Due to the limited energy resources and challenging communication medium, transmitting large amounts of data in UWSNs can be inefficient and may lead to energy wastage. Therefore, data compression and intelligent data transmission strategies are essential to optimize energy usage.

Deployment and Maintenance: Accessing and maintaining underwater sensor nodes can be challenging and costly. Diving or using underwater vehicles for deployment, retrieval, or maintenance operations requires careful planning and can be logistically complex.

In order to address the afore mentioned difficulties there is a requirement of a combination of advanced energy harvesting techniques, energy-efficient communication protocols, robust sensor design, and intelligent data management strategies. Researchers and engineers in the field of underwater sensor networks are continuously working on innovative solutions to overcome these challenges and improve the performance and reliability of energy harvesting nodes in aquatic settings. In this regard an extensive literature survey is presented below:

Bhattacharjya et al (CUWSN: energy efficient routing protocol selection for cluster based underwater wireless sensor network, Microsystem Technologies, 28 (2022), 543-559) focused on hop to hop communication method for abating the energy consumption. It has increased network longevity but suffers from hot-spot problem. Our embodiment addresses this issue while using the Energy Harvesting (EH)-enabled nodes. Faheem et al (QoSRP: A cross-layer QoS channel-aware routing protocol for the Internet of underwater acoustic sensor networks, Sensors 19, 21 (2019), 4762) described a Underwater Channel Detection (UWCD) which discovers unoccupied channels with a high detection probability and low missed detection and false alarms. Further, Underwater Channel Assignment (UWCA) assigns high-data-rate channels to ASNs with longer idle probabilities. This research work has enhanced throughput but doesn't consider energy consumption unlike the proposed embodiment. Faheem et al (QERP: Quality-of-service (QOS) aware evolutionary routing protocol for underwater wireless sensor networks, IEEE Systems Journal 12, 3 (2017), 2066-2073) also describes that in QERP, a reliable tiny clustering mechanism organizes sensor nodes into a connected hierarchy to fairly distribute energy and data traffic load in the network. QERP uses dependable connection quality information among CHs to send data to the sink. This research work has presented a qualitative link, but suffers from delay in data transmission. Khan et al (A multi-layer cluster based energy efficient (MLCEE) routing scheme for UWSNs, IEEE Access 7 (2019), 77398-77410) described that MLCEE has different stages, the first being network layering and the second being node clustering. To reduce hotspots, the first layer stays un-clustered and any node passes data directly to the sink, while CHs are picked based on Bayesian Probability and residual energy. This research work has acquired network longevity but energy consumption is also proliferated. Sangeeta Kumari et al (Fault resilient routing based on moth flame optimization scheme for underwater wireless sensor networks, Wireless Networks 26, 2 (2020), 1417-1431) described that in this method, Autonomous Underwater Vehicles (AUVs) are employed instead of CHs to avoid re-clustering and overloading. There may be a discontinuous path issue, thus authors added mobile nodes with AUVs. This research work has decreased delay; however, hots-spot problem still exists. Omeke et al (DEKCS: A dynamic clustering protocol to prolong underwater sensor networks, IEEE Sensors Journal 21, 7 (2021), 9457-9464) had studied a new underwater-based clustering algorithm. For CH selection, authors suggested DEKCS. A prospective CH is chosen depending on its position and battery level unlike proposed embodiment where CH selection is energy-efficient due to selection of additional parameters. This research work has increased network longevity but suffers from hot-spot problem. Rao et al (Cat Swarm Optimization based autonomous recovery from network partitioning in heterogeneous underwater wireless sensor network, International Journal of System Assurance Engineering and Management (2021), 1-15) explores CSO for detecting a likely network partition in the algorithm's seeking mode. In the algorithm's tracking mode, the cat nearest to the projected Articulation Points (AP) moves towards it to prevent network splitting. This research work has increased network longevity but suffers from hot-spot problem due to multi-hop communication unlike the proposed embodiment. Saeed et al (SEECR: secure energy efficient and cooperative routing protocol for underwater wireless sensor networks, IEEE Access 8 (2020), 107419-107433) described that SEECR is an energy-efficient and robust underwater defense system. SEECR improves network performance through cooperative routing. In resource-constrained UWSNs, minimum computation is used for security hence SEECR is acceptable for underwater environments. In this research work, performance is enhanced optimally but communication overheads are also enhanced unlike the proposed embodiment.

In this regard some patent literatures are also reviewed. Russell et al (Automatically deployed UAVs for disaster response, USOO9665094B1, Nov. 10, 2014) invented a remote-installed container which is exploited to give commands for deployment of UAV based on the disaster events. However, while considering the container for launching UAV, there could be a scenario, that can damage the container itself hence, it requires regular monitoring. Unlike this embodiment, the proposed embodiment relates to the cluster-based routing method that considers; (i) wherein a single UAV is considered to collect the data from the EH-enabled sensor nodes; (ii) the EH-enabled nodes are considered to be data collecting nodes from the underwater deployed nodes; (iii) Cluster-Head (CH) selection is performed using Artificial-Intelligence-based approach. Peeters et al (Providing services using UAV, U.S. Pat. No. 9,849,979 B2, May 5, 2016) proposed a set up for a swarm of UAV wherein a particular UAV is launched for addressing the medical emergency. However, this embodiment uses ultrasonic sensor which suffers from following: it cannot work in a vacuum; it is not designed for underwater use; it has a limited detection range (max 10 m). As a matter of fact, the speed of light is much faster than the speed of sound, therefore optical-based sensing is faster than ultrasonic, hence, latter can be preferred. The proposed embodiment deals with the data collection from the underwater-based scenario which is different area to what the discussed work is targeting i.e., medical healthcare. Sangar Dowlatkhah (Methods and apparatus to network UAVs, U.S. Pat. No. 9,788,260 B2, Feb. 16, 2016) described that when one UAV is in operation mode, the second UAV joins to the network to get the data from the sensor embodied in first UAV. The collection of payload data is the primary target for the second UAV. Payload data is not specified, which is again subjected to the various challenges encountered in different applications. The proposed embodiments have specified the application scenario, i.e., underwater sensor network. Henceforth, the challenges involved are handled in the proposed framework. Sharma et al (Methods and apparatus for providing over-the-air updates to Internet-of-things sensor nodes, U.S. Pat. No. 10,768,921 B2 Aug. 14, 2017) developed a firmware update delivery system for sensor nodes to which object is connected. A camera is used to takes pictures and an identifier is employed that utilizes them to identify an item. The update deliverer sends the sensor node firmware based on object recognition. UAV is used to make the changes in the operational mode of sensor nodes to achieve higher data rate. However, it not only exerts financial burden on the user in the context of compatibility of sensor node affording to have extra circuitry. Further, the energy consumption of sensor nodes will be very high due to operation at high frequency mode and for large data transfer. The proposed embodiment have focused on preserving the energy of sensor nodes unlike to what the discussed research work has intended to. Alexander J. Kube et al (System and method of collision Avoidance in unmanned aerial Vehicles, U.S. Pat. No. 10,366,616 B2, Jan. 8, 2016) In response to a request from the UAV controller (having UAV embedded with positional sensor), the safety data aggregator collects positional data from one or more UAV controllers, stores it in a safety data buffer, and then extracts spatially relevant positional data. Safety data aggregator which is located at the remote location makes used of GPS. However, it is very well known that using a GPS it requires 3 satellite to obtain positioning data but in practice UAV needs to communicate with at least 10 satellite to obtain a stable GPS system. Further, flying through tunnel will be a challenge for GPS supporting system. The proposed embodiment uses only single sink, hence, there is no need for collision avoidance system meant for swarm of UAVs. Ty Loren Carlson et al (UAV routing using real-time weather data, U.S. Pat. No. 99,597,711 Dec. 18, 2015) addresses the concern of operating the UAV in adverse weather conditions, wherein the employed UAV (having sensors installed onto it) is launched to collect weather information. Since this embodiment uses navigation system, it becomes a major hindrance in adverse environmental conditions. The proposed embodiment doesn't use any navigation system to avoid any weather dependent adverse scenarios. Christopher Hinkle et al (Route planning for unmanned Aeral vehicles, US 2016/0284221 A1, Mar. 25, 2016) et al describes that In this embodiment, the system receives a route request including an origin location and a destination location for a UAV and figures out a route for the UAV by examining the geospatial information. This embodiment deals with the routing path that is to be conveyed to the UAV for its flight. However, the routing technique which is to be followed is not specified. The proposed embodiment deals with routing technique that decides how the data among the sensor nodes should be forwarded and hence, UAV collects the data and send to the user finally. Asaf Gilboa et al proposes an automated system that collects and uses UAV and other travel related data to optimize UAV delivery scheduling and routing. Using the collected data from UAV sensors and other sources, the location and features of barriers, weather, crowds of people, magnetic interference, etc. can be used to calculate and update UAV flight plans. This embodiment exploits the logistic application using UAV. However, the travel related information can take some delay in reaching down to the UAV. Hence, the inevitable delay is expected to happen. The proposed embodiment is different from this embodiment in a way that it does not use navigation system which is weather dependent.

It is quite apparent that deployment of different sensors or combination of different sensors in UWSNs helps researchers and environmentalists to gather valuable data on oceanography, marine life, water quality, and environmental changes in underwater ecosystems, contributing to a better understanding of the planet's aquatic environments. Based on the above discussions it is found that multiple UAV-assisted Underwater Wireless Sensor Network (UWSN) is still not explored. This requires designing of a novel system and methods for UAV-assisted (UWSN).

### OBJECT OF THE INVENTION

It is thus the basic object of the present invention is to develop a system and method for establishing energy-optimized UAV-assisted underwater wireless sensor network.

Another object of the present invention is to develop a system and method for establishing energy-optimized UAV-assisted underwater wireless sensor network to collect data from sensor nodes placed underwater through deployment of a set number of gateway nodes equipped with solar harvesting module embedded on to them.

Yet another object of the present invention is to develop a system and method for establishing energy-optimized UAV-assisted underwater wireless sensor network which can reduce the impact of the hot-spot issue in the network.

A still further object of the present invention is to develop a control mechanism to optimize the energy management of underwater sensor nodes which includes activating sensor nodes strategically, reducing transmission power, and coordinating with the UAV for data collection.

### SUMMARY OF THE INVENTION

Thus, according to basic aspect of the present invention there is provided a system for establishing energy-optimized UAV-assisted underwater wireless sensor network comprising plurality of underwater sensor nodes, said sensor nodes are clustered, whereby cluster member nodes send data to a cluster head (CH) node;

plurality of energy harvesting (EH)-enabled nodes deployed over surface of the water for receiving data sent from said CH node;

one or more Unmanned Aerial Vehicle (UAV) for receiving data from said CH node or said EH enabled nodes;

a UAV traffic controller (UTC) to control the UAVs including connecting the UAVs to cellular network.

In a preferred embodiment, the cluster member nodes are subjected for continuous checking of energy, whereby if energy of a node is greater than zero, the cluster nodes transmit data to the selected CH by following Time Division Multiple Access (TDMA) scheduling otherwise the node is said to be a dead node.

In a preferred embodiment, the CH nodes involves data aggregation to forward data to the nearest EH enabled node, whereby the EH enabled nodes are subjected for continuous checking of energy and if energy of the EH enabled node is greater than a threshold level of energy, the EH enabled node sends data packets to the UAV otherwise no data will be transmitted to EH enabled node and again energy of EH enabled node is checked.

In a preferred embodiment, the selection of CH is done using GJO method which includes Search Behavior, Population-Based Approach, creating an Objective Function, Foraging and Hunting, Movement and Interaction, Exploration and Exploitation, Memory and Learning and finally Termination Criteria.

In a preferred embodiment, the sensor nodes are clustered based on TDMA scheduling to enhance the network's efficiency and energy utilization.

In a preferred embodiment, the system includes Battery Fuel Gauge ICs to measure energy levels of the EH enabled nodes and cluster member nodes.

In a preferred embodiment, the UAV traffic controller (UTC) includes UAV Communication Modules that allow the UAV to connect to the cellular network;

UTC Command Center or Ground Control Station from where UAV operators, flight controllers, and other personnel monitors control multiple UAVs simultaneously;

Cellular Network Connectivity module to establish the cellular network connection with the UAV communication modules which also enables bidirectional communication between the UAV and the UTC Command Center over the cellular infrastructure;

Data Transmission and Telemetry includes telemetry data (e.g., GPS location, altitude, speed, battery status) sent by the UAV to the UTC for real-time monitoring and situational awareness;

Commands and Control Signals sent to the UAV through the cellular network from the UTC Command Center and the commands include instructions for flight path adjustments, altitude changes, payload operations, and other flight-related actions;

Network Quality and Latency for ensuring a stable and low-latency connection is critical for real-time control of UAVs, especially in critical applications like surveillance, emergency response, or delivery services.

Authentication and encryption protocols to secure the communication between the UAV and the UTC Command Center. to prevent unauthorized access and ensure data privacy;

Redundancy and Fail-Safe Mechanisms for enhancing reliability and safety, redundant communication paths wherein the redundancy and fail-safe mechanisms involves multiple cellular networks, satellite links, or even backup radio communication systems in case the primary connection is lost;

Sink for receiving data forwarded from the UAV.

In a preferred embodiment, the cluster-member nodes which are closely located to each other, one of two such nodes, is put to sleep mode until its energy gets lower than the threshold value using sleep-scheduling mechanism.

In a preferred embodiment, the sensor nodes include anyone or more of acoustic sensors, pressure sensors, temperature sensors, salinity sensors, dissolved oxygen sensors, turbidity sensors, chemical sensors.

In a preferred embodiment, the EH enabled nodes are powered through solar-harvesting method.

In another preferred embodiment, a method for energy-optimized UAV-assisted underwater wireless sensor network comprising
a. installing set up for operating UAV;
b. deploying underwater sensor nodes and placing the EH enabled sensor nodes on the surface of water;
c. establishing a cellular communication network;
d. selection of cluster head (CH) using Golden Jackel Optimization method;
e. checking/measuring energy of the sensor nodes continuously, if energy of node is greater than zero, cluster nodes transmit data to the selected CH by following TDMA scheduling otherwise the node is said to be a dead node;
f. performing data aggregation and forwarding data to the nearest EH enabled nodes;
g. checking/measuring energy of EH enabled node, if the energy of EH enabled node is greater than threshold level of energy EH enabled node sends data packets to UAV otherwise no data A method will be transmitted to EH enabled node and again checking energy of EH enabled node;
h. sending data to user from UAV by using the cellular communication network and if all the nodes are dead, the network is said to be dead else the network keeps operating.

### BRIEF DESCRIPTION OF THE DRAWINGS

FIG. 1 represents proposed routing architecture of EOURM in accordance with an embodiment of the present invention.

FIG. 2 represents proposed process for demonstrating the EOURM functioning in accordance with an embodiment of the present invention.

FIG. 3 depicts the flow chart for data transmission among the underwater sensor nodes and the UAV in accordance with an embodiment of the present invention.

### DETAILED DESCRIPTION OF THE INVENTION

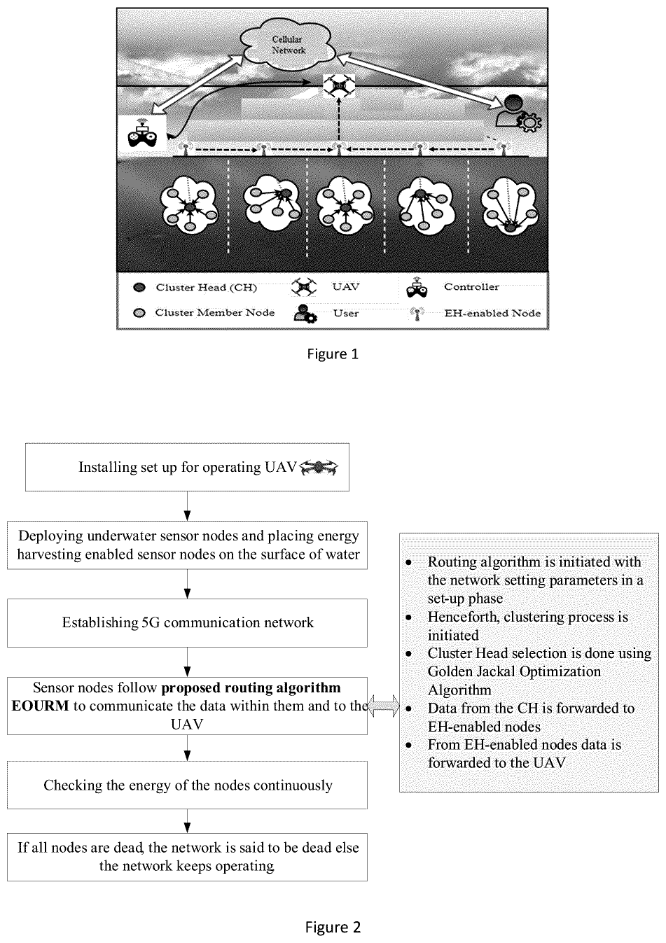

The first reference is invited from FIG. 1, where the underwater sensor network (UWSN) is deployed for data dissemination. The UWSN includes various type of sensor nodes such as acoustic sensors, pressure sensors, temperature sensors, salinity sensors, dissolved oxygen sensors, turbidity sensors, chemical sensors or likewise. The sensor nodes form clusters and the cluster member nodes send data to the selected Cluster Head (CH) node. The selection of CH is done using Golden Jackal Optimization (GJO) method. EH-enabled nodes are deployed over the surface of water for different reasons such as solar energy harvesting higher energy yield, ease of deployment, reduced fouling and corrosion, improved communication, easy access for maintenance, spatial coverage and area monitoring and supporting floating sensor arrays. These nodes are powered through solar-harvesting method and the CH nodes send data to these nodes. The important point to note here is the sleep-scheduling mechanism that these sensor nodes follow. The cluster-member nodes which are closely located to each other, one of two such nodes, is put to sleep mode until its energy gets lower than the threshold value. This process works alternatively for aforesaid nodes. Further, the collected data by the CH is sent to the nearest EH-enabled node, from there it is sent to the EH-enabled node or to the hovering UAV depending upon whosoever is nearest to the data transmitting EH-enabled node. Finally, from UAV, data is forwarded to the sink.

UAV is controlled through UAV traffic controller through the cellular network. Controlling Unmanned Aerial Vehicles (UAVs) through a UAV Traffic Controller (UTC) using the cellular network involves a combination of communication technologies and protocols to ensure efficient and secure command and control of the UAVs. The overview of the process is discussed below:

UAV Communication Modules: UAVs are equipped with communication modules that allow them to connect to the cellular network. These modules may include cellular modems or transceivers compatible with the specific cellular technology being used (e.g., 4G LTE, 5G).

UTC Command Center: The UAV Traffic Controller operates from a centralized Command Center or Ground Control Station. This is where the UAV operators, flight controllers, and other personnel monitor and control multiple UAVs simultaneously.

Cellular Network Connectivity: UAVs establish a cellular network connection using the communication modules onboard. This connection enables bidirectional communication between the UAV and the UTC Command Center over the cellular infrastructure.

Data Transmission and Telemetry: The cellular network facilitates the exchange of data between the UAV and the UTC Command Center. This includes telemetry data (e.g., GPS location, altitude, speed, battery status) sent by the UAV to the UTC for real-time monitoring and situational awareness.

Commands and Control Signals: The UTC Command Center sends control signals and commands to the UAV through the cellular network. These commands include instructions for flight path adjustments, altitude changes, payload operations, and other flight-related actions.

Network Quality and Latency: Cellular networks provide varying levels of signal strength and data throughput depending on the location and network coverage. Ensuring a stable and low-latency connection is critical for real-time control of UAVs, especially in critical applications like surveillance, emergency response, or delivery services.

Security and Authentication: As UAVs are remotely controlled through the cellular network, robust security measures are essential to prevent unauthorized access and ensure data privacy. Authentication and encryption protocols are used to secure the communication between the UAV and the UTC Command Center.

Redundancy and Fail-Safe Mechanisms: To enhance reliability and safety, redundant communication paths and fail-safe mechanisms may be implemented. This can involve using multiple cellular networks, satellite links, or even backup radio communication systems in case the primary connection is lost.

Regulatory Compliance: When operating UAVs over cellular networks, compliance with aviation and telecom regulations is crucial. The UTC Command Center must adhere to relevant laws and regulations concerning UAV operations and spectrum usage for cellular communication.

By utilizing the cellular network for UAV control, the UTC can efficiently manage and monitor multiple UAVs simultaneously, enabling a wide range of applications, from aerial photography and surveillance to drone deliveries and disaster response. However, it's important to consider the network's limitations, potential signal interference, and security aspects to ensure safe and effective UAV operation.

Another reference is invited from FIG. 2 which depicts the proposed process for demonstrating the EOURM functioning first a set up for operating UAV has been installed, underwater sensor nodes are deployed and the EH enabled sensor nodes on the surface of water are placed. Then a 5G communication network has been established. Sensor nodes follow proposed routing algorithm EOURM to communicate the data within them and to the UAV. Wherein the routing algorithm is initiated with the network setting parameters in a setup phase, clustering process is initiated through selection of CH using GJO method. Data from CH is forwarded to EH enabled nodes and further forwarded to the UAV. The energy of the nodes are checked continuously and If all the nodes are dead, the network is said to be dead else the network keeps operating.

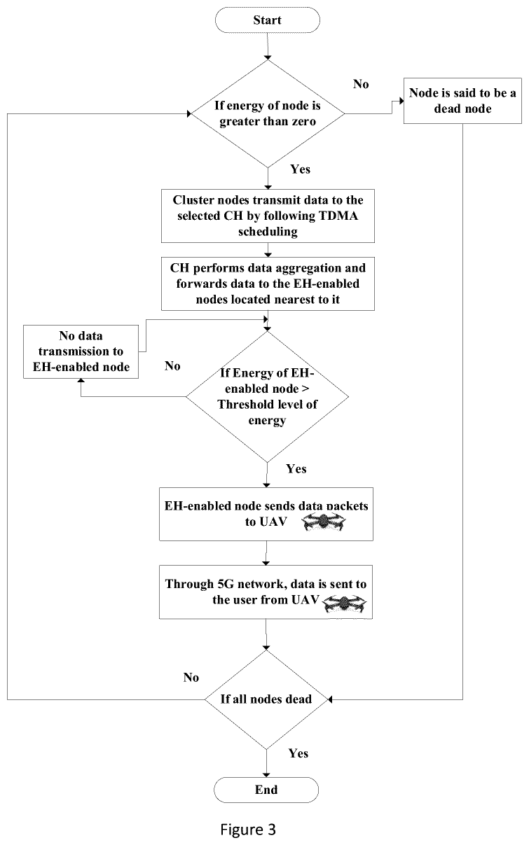

Another reference is invited from FIG. 3, wherein a flow diagram of method for data transmission among the underwater sensor nodes and the UAV has been depicted. The method is as follows.

Energy of the sensor nodes are checked/measured continuously, if energy of node is greater than zero, cluster nodes transmit data to the selected CH by following Time Division Multiple Access (TDMA) scheduling otherwise the node is said to be a dead node. Then data aggregation has been performed and data is forwarded to the nearest EH enabled nodes. Energy of EH enabled node is continuously checking/measuring, if the energy of EH enabled node is greater than threshold level of energy EH enabled node sends data packets to UAV otherwise no data will be transmitted to EH enabled node and again energy of EH enabled node is checked. Then the data to user from UAV is sent by using 5G network, if all the nodes are dead, the network is said to be dead else the network keeps operating.

It is mentioned that the selection of CH is done using GJO method wherein the method is a nature-inspired optimization algorithm inspired by the foraging behaviour of golden jackals, which are medium-sized carnivorous animals found in various regions of the world. The GJO algorithm is used to solve optimization problems by mimicking the hunting and foraging strategies of these animals. The GJO method includes Search Behavior, Population-Based Approach, creating an Objective Function, Foraging and Hunting, Movement and Interaction, Exploration and Exploitation, Memory and Learning and finally Termination Criteria. By following the principles of GJO, the algorithm aims to efficiently explore the solution space, converge to better solutions over time, and find optimal or near-optimal solutions for various optimization problems. GJO has been applied to a wide range of optimization tasks and has shown promising results in terms of convergence speed and accuracy compared to other nature-inspired optimization algorithms.

Clustering algorithms which are used in wireless sensor networks, TDMA scheduling is employed to enhance the network's efficiency and energy utilization. In these algorithms, the sensor nodes are organized into clusters, and one node within each cluster is designated as the cluster head. The cluster head is responsible for coordinating communication within its cluster and relaying data between the cluster members and the base station or sink node.

TDMA scheduling is applied in the communication process within each cluster to avoid collisions and provide time-slotted access to the channel. Each cluster head allocates specific time slots to its cluster members, and they transmit their data only during their assigned time slots. This approach ensures that no two nodes within the same cluster interfere with each other's transmissions, leading to reduced packet collisions and improved network performance. By using TDMA scheduling within each cluster, clustering algorithms can achieve several benefits like Energy Efficiency, Reduced Interference, Load Balancing, Scalability. TDMA scheduling used in clustering algorithms for wireless sensor networks promotes efficient data transmission, minimizes energy wastage, and enhances network performance in terms of throughput and reliability.

It is to be mentioned that measuring the energy levels of EH (Energy Harvesting)-enabled nodes in a Wireless Sensor Network (WSN) is a crucial aspect of energy management and decision-making processes. To determine the energy levels, various methods and instruments can be used depending on the specific sensor nodes and the energy harvesting technology employed. Some common approaches to measure the energy of EH-enabled nodes includes Battery Fuel Gauge ICs which can accurately measure the remaining energy in the batteries and provide information on battery voltage, current, temperature, and state of charge (SOC), Energy Harvesting Monitoring Circuitry which is used to keep track of the energy harvested from ambient sources, such as solar panels, kinetic energy harvesters, or piezoelectric generators and measure and records the harvested energy over time. Energy Harvesting Controller that interfaces with the energy harvesting source (e.g. solar panel controller) and monitor the energy generation. Power Management Unit (PMU) that handles power-related operations, including energy measurement and management, Software-Based Energy Estimation algorithms use battery discharge curves or other models to estimate the remaining energy.

| Abbreviation | Meaning |
|---|---|
| EOURM | Energy-Optimized UAV-assisted Routing Method |
| UWSN | Underwater Wireless Sensor Network |
| CH | Cluster Head |
| EH | Energy Harvesting |
| GJO | Golden Jackal Optimization |

1. A system for establishing energy-optimized UAV-assisted underwater wireless sensor network comprising
plurality of underwater sensor nodes, said sensor nodes are clustered, whereby cluster member nodes send data to a cluster head (CH) node;
plurality of energy harvesting (EH)-enabled nodes deployed over surface of the water for receiving data sent from said CH node;
one or more Unmanned Aerial Vehicle (UAV) for receiving data from said CH node or said EH enabled nodes;
a UAV traffic controller (UTC) to control the UAVs including connecting the UAVs to cellular network.

2. The system as claimed in claim 1, wherein the cluster member nodes are subjected for continuous checking of energy, whereby if energy of a node is greater than zero, the cluster nodes transmit data to the selected CH by following Time Division Multiple Access (TDMA) scheduling otherwise the node is said to be a dead node.

3. The system as claimed in claim 1, wherein the CH nodes involves data aggregation to forward data to the nearest EH enabled node, whereby the EH enabled nodes are subjected for continuous checking of energy and if energy of the EH enabled node is greater than a threshold level of energy, the EH enabled node sends data packets to the UAV otherwise no data will be transmitted to EH enabled node and again energy of EH enabled node is checked.

4. The system as claimed in claim 1, wherein the selection of CH is done using GJO method which includes Search Behavior, Population-Based Approach, creating an Objective Function, Foraging and Hunting, Movement and Interaction, Exploration and Exploitation, Memory and Learning and finally Termination Criteria.

5. The system as claimed in claim 1, wherein the sensor nodes are clustered based on TDMA scheduling to enhance the network's efficiency and energy utilization.

6. The system as claimed in claim 1, includes Battery Fuel Gauge ICs to measure energy levels of the EH enabled nodes and cluster member nodes.

7. The system as claimed in claim 1, wherein the UAV traffic controller (UTC) includes UAV Communication Modules that allow the UAV to connect to the cellular network;
UTC Command Center or Ground Control Station from where UAV operators, flight controllers, and other personnel monitors control multiple UAVs simultaneously;
Cellular Network Connectivity module to establish the cellular network connection with the UAV communication modules which also enables bidirectional communication between the UAV and the UTC Command Center over the cellular infrastructure;
Data Transmission and Telemetry includes telemetry data (e.g., GPS location, altitude, speed, battery status) sent by the UAV to the UTC for real-time monitoring and situational awareness;
Commands and Control Signals sent to the UAV through the cellular network from the UTC Command Center and the commands include instructions for flight path adjustments, altitude changes, payload operations, and other flight-related actions;
Network Quality and Latency for ensuring a stable and low-latency connection is critical for real-time control of UAVs, especially in critical applications like surveillance, emergency response, or delivery services.
Authentication and encryption protocols to secure the communication between the UAV and the UTC Command Center. to prevent unauthorized access and ensure data privacy;
Redundancy and Fail-Safe Mechanisms for enhancing reliability and safety, redundant communication paths wherein the redundancy and fail-safe mechanisms involves multiple cellular networks, satellite links, or even backup radio communication systems in case the primary connection is lost;
Sink for receiving data forwarded from the UAV.

8. The system as claimed in claim 1, wherein cluster-member nodes including the nodes which are closely located to each other, one of two such nodes, is put to sleep mode until its energy gets lower than the threshold value using sleep-scheduling mechanism.

9. The system as claimed in claim 1, wherein the sensor nodes include anyone or more of acoustic sensors, pressure sensors, temperature sensors, salinity sensors, dissolved oxygen sensors, turbidity sensors, chemical sensors.

10. The system as claimed in claim 1, wherein the EH enabled nodes are powered through solar-harvesting method.

11. A method for energy-optimized UAV-assisted underwater wireless sensor network comprising
a. installing set up for operating UAV;
b. deploying underwater sensor nodes and placing the EH enabled sensor nodes on the surface of water;
c. establishing a cellular communication network;
d. selection of cluster head (CH) using Golden Jackel Optimization method;
e. checking/measuring energy of the sensor nodes continuously, if energy of node is greater than zero, cluster nodes transmit data to the selected CH by following TDMA scheduling otherwise the node is said to be a dead node;
f. performing data aggregation and forwarding data to the nearest EH enabled nodes;
g. checking/measuring energy of EH enabled node, if the energy of EH enabled node is greater than threshold level of energy EH enabled node sends data packets to UAV otherwise no data A method will be transmitted to EH enabled node and again checking energy of EH enabled node;
h. sending data to user from UAV by using the cellular communication network and if all the nodes are dead, the network is said to be dead else the network keeps operating.
